(19) United States
(12) Patent Application Publication
(10) Pub. No.: US 2024/0192331 A1
(43) Pub. Date: Jun. 13, 2024

(54) INTERFERENCE REDUCTION

(71) Applicant: Innovusion, Inc., Sunnyvale, CA (US)

(72) Inventors: Zachary Wu, Sunnyvale, CA (US); Philip Andrew Wingard, Mission Viejo, CA (US); Wenxu Zhang, Newark, CA (US); Peng Wan, San Jose, CA (US)

(73) Assignee: Innovusion, Inc., Sunnyvale, CA (US)

(21) Appl. No.: 18/533,048

(22) Filed: Dec. 7, 2023

Related U.S. Application Data
(60) Provisional application No. 63/432,327, filed on Dec. 13, 2022.

(51) Int. Cl. G01S 7/481; G01S 7/487; G01S 17/931

(52) U.S. Cl. CPC G01S 7/4817; G01S 7/487; G01S 17/931

(57) ABSTRACT

A method for reducing interference in a light ranging and detection (LiDAR) system is provided. The method comprises receiving noise by a light detector of the LiDAR system, determining whether the received noise is caused by interference from at least one other LiDAR system, and in accordance with a determination that the detected noise is caused by interference from the at least one other LiDAR system, de-synchronizing the LiDAR system with the at least one other LiDAR system.

### CROSS-REFERENCE TO RELATED APPLICATIONS

This application claims priority to U.S. Provisional Patent Application Ser. No. 63/432,327, filed Dec. 13, 2022, entitled “Interference Reduction,” the content of which is hereby incorporated by reference in its entirety for all purposes.

### FIELD OF THE TECHNOLOGY

This disclosure relates generally to light transmission, detection, and sensing, and, more particularly, to methods for reducing interference between a plurality of light detection and ranging (LiDAR) systems.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

When multiple vehicles installed with LiDAR systems are operating in the field, e.g., driving on the road or idling in parking structures, the light detection and ranging function of one LiDAR system may be interfered by other LiDAR systems that are close by. Interference may be caused by synchronization of nearby LiDAR systems. Consequently, false objects or noises may appear in the point cloud of the affected LiDAR system. Interference can lead to errors in the further processing of the LiDAR point cloud data. Any inaccuracies in the LiDAR data may pose a risk to the safety of vehicle's operation. Therefore, it is important to timely detect the interference and reduce the interference when it happens.

Traditional approaches to interference reduction involve post-hoc methods. For example, noise points in the point cloud caused by interference are filtered out by control circuits using algorithms. However, this reactive strategy relies on the LiDAR system awaiting the occurrence of interference before taking remedial actions. Moreover, it demands increased computing power from a processor such as a Field Programmable Gate Array (FPGA) based processor. There is also a risk of erroneous determinations. Instead, the methods presented in this disclosure address the root cause of interference when it occurs, thereby proactively preventing further interference.

Another method to reduce interference involves encoding the light pulses transmitted by LiDAR systems. However, this approach requires a more complicated LiDAR system design, increased bandwidth, and additional light energy. It also imposes higher computing power requirements. Methods disclosed in this disclosure can be applied to LiDAR systems with or without encoding schemes. They can be applied when two LiDAR systems have the same encoding schemes.

In one embodiment, a method for reducing interference in a light ranging and detection (LiDAR) system is provided. The method comprises receiving noise by a light detector of the LiDAR system, determining whether the received noise is caused by interference from at least one other LiDAR system, and in accordance with a determination that the detected noise is caused by interference from the at least one other LiDAR system, de-synchronizing the LiDAR system with the at least one other LiDAR system.

In another embodiment, a LiDAR system for reducing interference in the LIDAR system is provided. The LiDAR system comprises one or more processors, a memory device, and processor-executable instructions stored in the memory device. The processor-executable instructions comprise instructions for receiving noise by a light detector of the LiDAR system, determining whether the received noise is caused by interference from at least one other LiDAR system, and in accordance with a determination that the detected noise is caused by interference from the at least one other LiDAR system, de-synchronizing the LiDAR system with the at least one other LiDAR system.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7A illustrates one interference scenario when two close-by LiDAR systems are scanning in the same direction according to one embodiment.

FIG. 7B illustrates another interference scenario when two close-by LiDAR systems are scanning towards each other according to one embodiment.

FIG. 8A illustrates a top view of two vehicles installed with LiDAR systems driving on a three-lane roadway according to one embodiment.

FIG. 8B illustrates a LiDAR view of a road scene perceived by a first vehicle driving in the middle lane of a three-lane roadway according to one embodiment.

FIG. 8C illustrates a LiDAR view of a road scene perceived by a second vehicle driving in the right lane of a three-lane roadway according to one embodiment.

FIG. 9A illustrates a two-dimensional scan pattern scanned by the steering mechanism of a first LiDAR system according to one embodiment.

FIG. 9B illustrates a two-dimensional scan pattern scanned by the steering mechanism of a second LiDAR system according to one embodiment.

FIG. 10A illustrates two timing diagrams showing light pulses transmitted and received by two LiDAR systems when their light sources are synchronized according to one embodiment.

FIG. 10B illustrates two timing diagrams showing the light pulses transmitted and received by two LiDAR systems when their light sources are not synchronized according to one embodiment.

FIG. 11 illustrates a plot demonstrating the correlation between the occurrence of interference points in a frame and the time delays between two LiDAR systems according to one embodiment.

FIG. 12 illustrates a close-up view of FIG. 11 when the time delay is within a 2.5 milliseconds range according to one embodiment.

FIG. 13 is a flowchart illustrating a method for reducing interference in a LiDAR system according to one embodiment.

FIG. 14 is a flowchart illustrating a method for determining whether the received noise is caused by interference from other LiDAR systems according to one embodiment.

FIG. 15 is a flowchart illustrating a second method for determining whether the received noise is caused by interference from other LiDAR systems according to one embodiment.

FIG. 16 is a flowchart illustrating a third method for determining whether the received noise is caused by interference from other LiDAR systems according to one embodiment.

FIG. 17 is a flowchart illustrating a fourth method for determining whether the received noise is caused by interference from other LiDAR systems according to one embodiment.

FIG. 18 is a flowchart illustrating a method for de-synchronizing two light steering mechanisms of two LiDAR systems according to one embodiment.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

When multiple vehicles with LiDAR systems operate together, interference may occur, potentially leading to false objects or noises in the affected LiDAR system's point cloud. This interference, caused by synchronization with nearby LiDAR systems, poses a safety risk and can introduce errors during data processing. Timely detection and reduction of interference are important. Traditional approaches involve post-hoc methods. The disclosed methods proactively address the root cause of interference, preventing further interferences. Another method involves encoding light pulses, but it requires a more complex LiDAR system design and higher computing power. The disclosed methods can be applied to LiDAR systems with or without encoding schemes.

Embodiments of the present invention are described below. In various embodiments of the present invention, a method for reducing interference in a light ranging and detection (LiDAR) system is provided. The method comprises receiving noise by a light detector of the LiDAR system, determining whether the received noise is caused by interference from at least one other LiDAR system, and in accordance with a determination that the detected noise is caused by interference from the at least one other LiDAR system, de-synchronizing the LiDAR system with the at least one other LiDAR system.

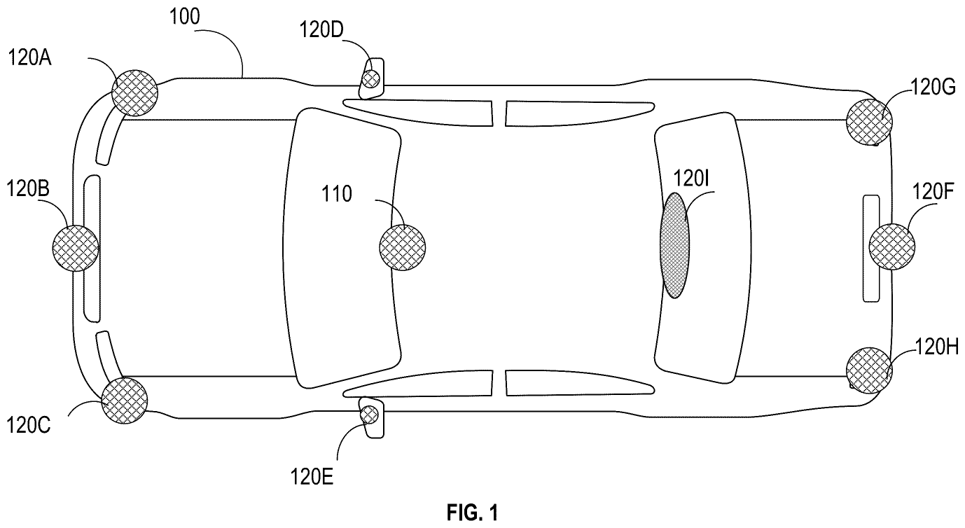

FIG. 1 illustrates one or more example LiDAR systems 110 and 120A-120I disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but has no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

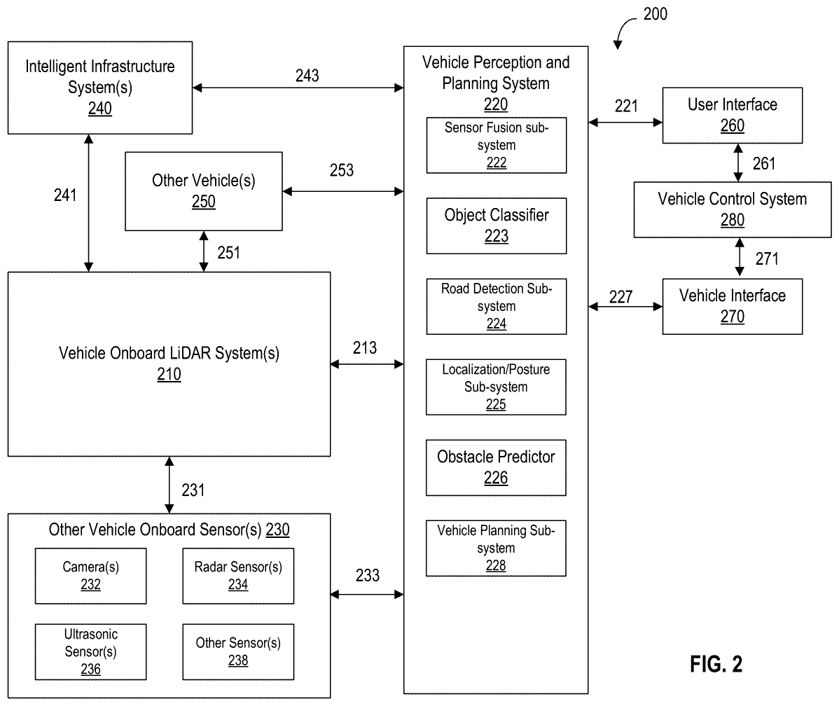

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitate producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any location (e.g., rear-view mirrors, pillars, front grille, and/or back bumpers, etc.).

Other vehicle onboard sensos(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located near the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any location (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 227 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

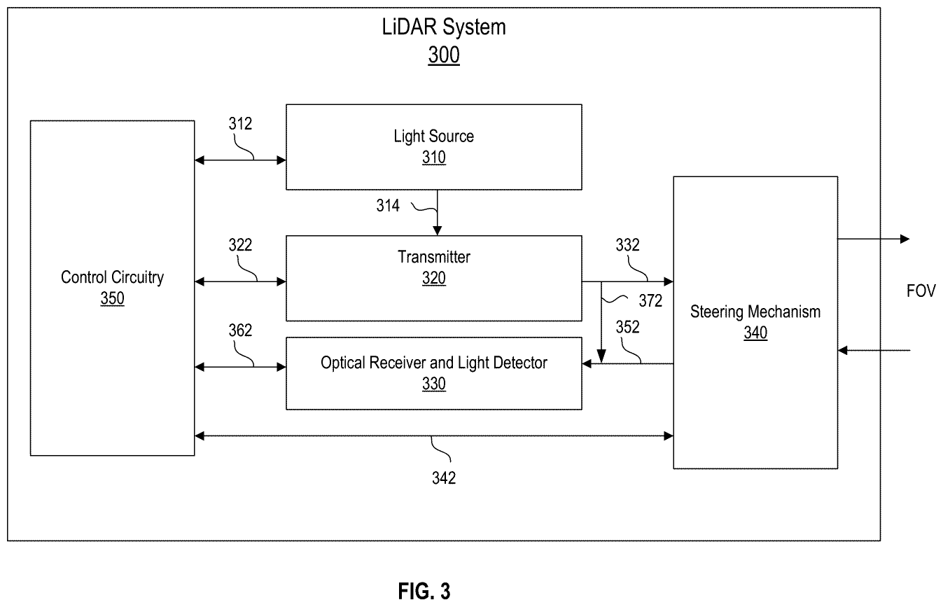

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. Route 372 may include one or more optics (e.g., optical fibers, lens, mirrors, etc.) for providing the light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, prascodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO4) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

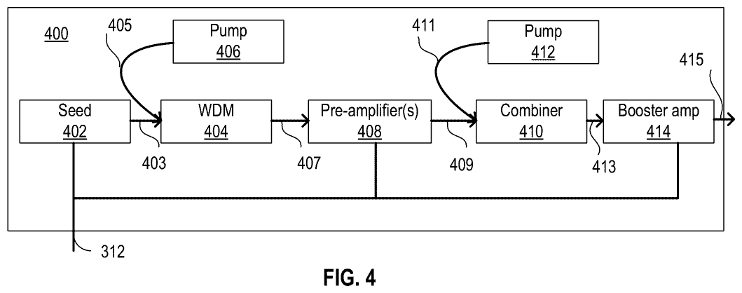

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 415. The booster amplifier 414 provides further amplification of the optical signals (e.g., another 20-40 dB). The output light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M2 factor) is used for measurement of laser beam quality. In many LiDAR applications, it is important to have good laser beam quality in the generated transmitting laser beam. The M2 factor represents a degree of variation of a beam from an ideal Gaussian beam. Thus, the M2 factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M2 factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structures can be used for a light detector. For example, a light detector structure can be a PIN based structure, which has an undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LIDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic scaling may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, buses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

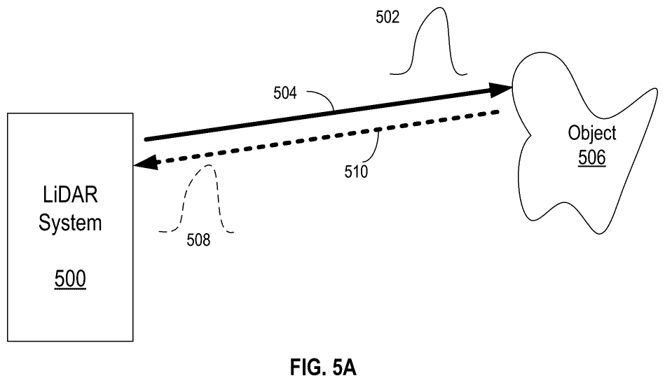

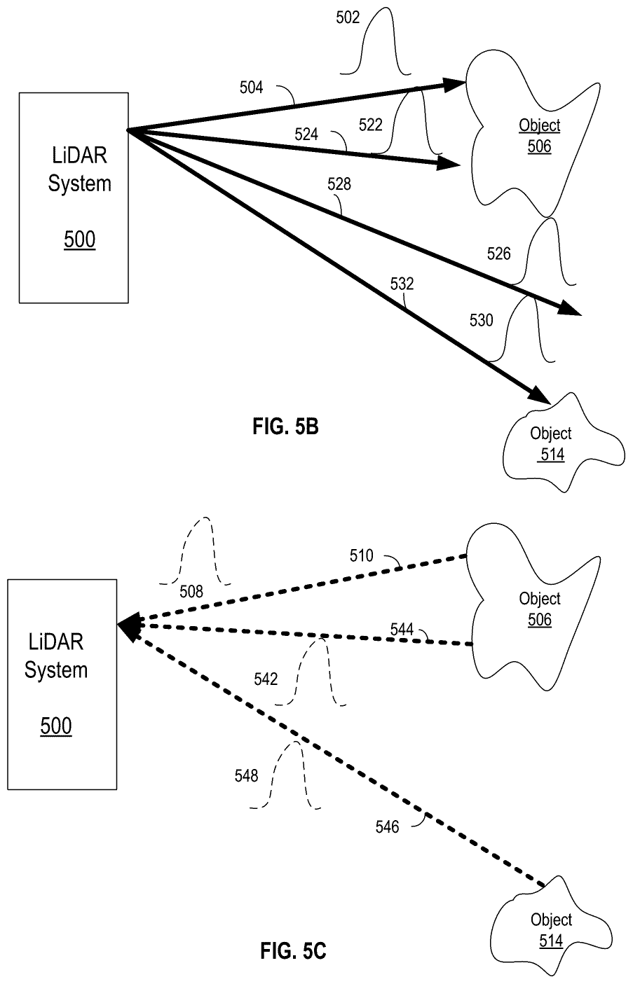

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHZ (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

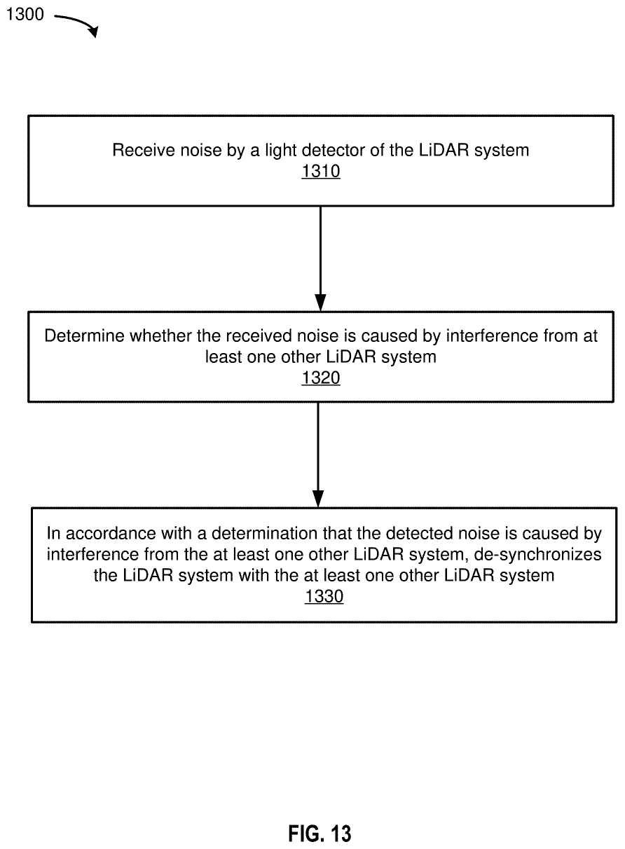

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of FIGS. 13-18, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

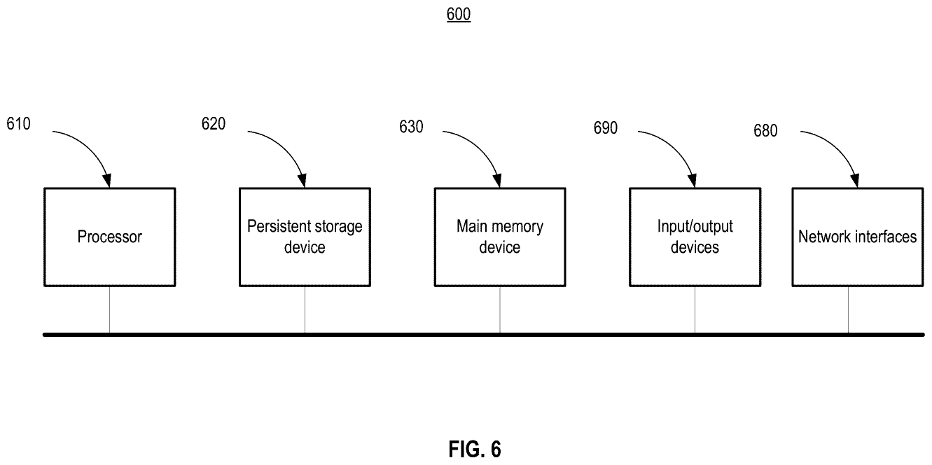

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of FIGS. 13-18 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with FIGS. 13-18. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

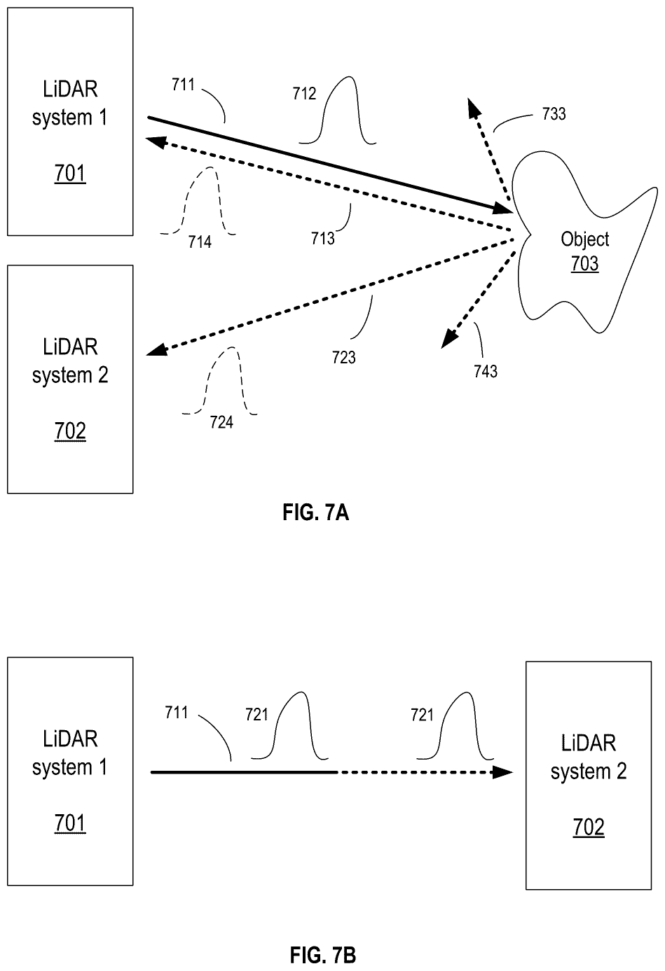

Interference may happen when two or more LiDAR systems are close by. FIG. 7A illustrates one interference scenario when two close-by LiDAR systems are scanning generally in the same direction according to one embodiment. LiDAR system 1 (701) and LiDAR system 2 (702) may be installed on the top of two separate vehicles (not shown in the figure). The two vehicles are close by and are facing the same direction. For example, the two vehicles may be both parked (with the LiDAR systems activated) in two adjacent parking spaces in a parking lot, or the two vehicles may be both driving on the road parallel to each other, towards the same direction, and in two adjacent lanes.

LiDAR systems 701 and 702 are similar to LiDAR system 500 in FIG. 5A, and can be implemented using, for example, LiDAR system 300 described above. Each of the LiDAR system 701 and 702 may include a light source (e.g., a fiber laser), a steering mechanism (e.g., a system of one or more moving mirrors), and a light detector (e.g., a photodetector with one or more optics). Similar to LiDAR system 500, both LiDAR systems 701 and 702 are able to transmit and receive lights to detect external objects. LiDAR system 701 transmits an outgoing light pulse 712 along light path 711 towards the direction determined by the steering mechanism at a particular moment. When outgoing pulse 712 reaches external object 703, it may scatter in multiple directions. For example, as depicted in FIG. 7A, outgoing pulse 712 may scatter along several light paths 713, 723, 733, and 743. It should be understood that pulse 712 may scatter along various other light paths in multiple directions. For simplicity, only four possible light paths are shown in the figure.

After pulse 712 is scattered by object 703, a first scattered light pulse 714 is formed. First scattered pulse 714 is directed back to system 701 along light path 713, and is detected by the light detector of system 701. As previously explained, distance from system 701 to object 703 can then be calculated based on the time-of-flight of scattered pulse 714.

After pulse 712 is scattered by object 703, a second scattered light pulse 724 may also be formed. Unlike the first scattered pulse 714, second scattered pulse 724 is directed towards system 702 along light path 723. If at the same time, system 702 happens to be also scanning towards the direction of object 703 and is detecting a scattered pulse, scattered pulse 724 may be detected by system 702 and deemed as a valid return. However, since the time-of-flight of scattered pulse 724 is not based on any transmitted pulses of system 702, calculating the distance from system 702 to object 703 would result in an error. Multiple such erroneous calculations can lead to the appearance of false objects or noise in the point cloud of system 702, giving rise to an inference.

One LiDAR system may cause interferences in multiple other LiDAR systems nearby. As depicted in FIG. 7A, pulse 712 can scatter along light paths 733 and 743. In the absence of LiDAR systems along those paths, interference would not occur. However, if, for instance, a third LiDAR system were present along light path 733 (not depicted in the figure), interference might occur if the third LiDAR system is simultaneously scanning in the direction of object 703.

FIG. 7B illustrates another interference scenario when two close-by LiDAR systems are scanning towards each other according to one embodiment. Similar to FIG. 7A, LiDAR system 701 and LiDAR system 702 are installed on top of two separate vehicles (not shown in the figure). The two vehicles are close by and are facing each other. For example, the two vehicles may be both parked (with LiDAR systems activated) in two opposite parking spaces in a parking lot, or the two vehicles may be driving towards each other on a two way street.

LiDAR system 701 transmits an outgoing light pulse 721 along light path 711. In this context, path 711 is directed towards system 702. With respect to system 701, system 702 is an external object, and vice versa. At the same time, system 702 happens to be also scanning towards the direction of system 701 and is detecting a scattered pulse along the same path 711. In this scenario, the same pulse 721 originating from system 701 may be detected by system 702 and deemed as a valid return. However, because the time-of-flight of pulse 721 is not based on any of the transmitted pulses of system 702, the distance calculation from system 702 to system 701 would be erroneous. As a result, false objects or noises may appear in system 702's point cloud and an inference has occurred.

Compared to the interference scenario of FIG. 7A, the interference scenario of FIG. 7B presents a relatively less severe issue. This is because in the latter scenario, false objects or noises appear around the location of system 701's housing in the point cloud of system 702. When two vehicles are driving towards each other, the LiDAR system housing installed on the opposite vehicle may occupy just a small area in the point cloud. On the contrary, in the former scenario, external objects can appear throughout the point cloud and can vary in size. Consequently, fake objects or noise resulting from interference can appear at any location within the point cloud and may vary in size. This poses a greater safety concern for driving. To better illustrate the former scenario (where two LiDAR systems are scanning in the same direction), a scenario of two vehicles driving side-by-side on a three-lane roadway is depicted in the figures below.

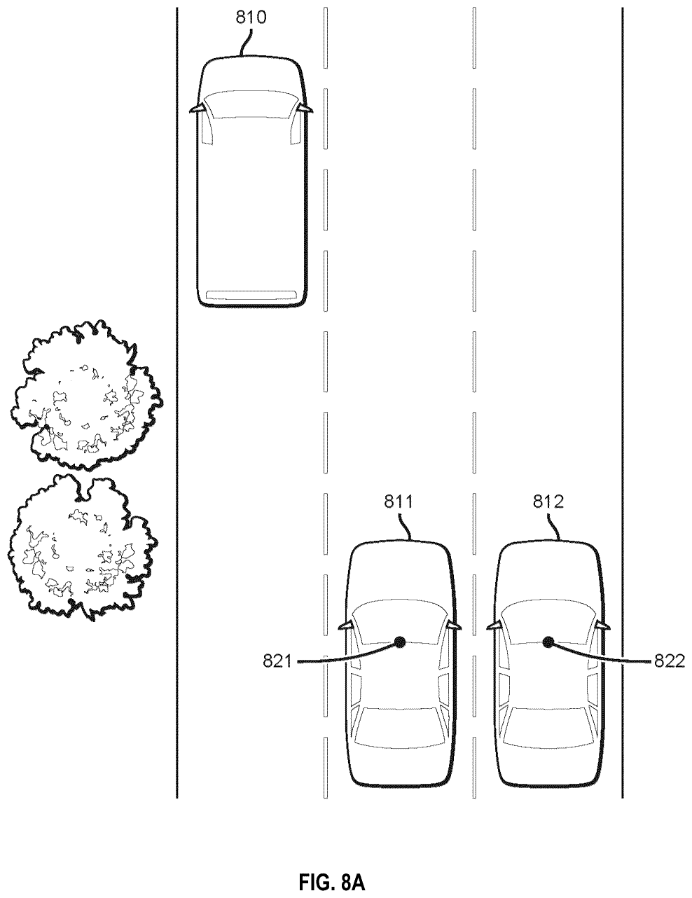

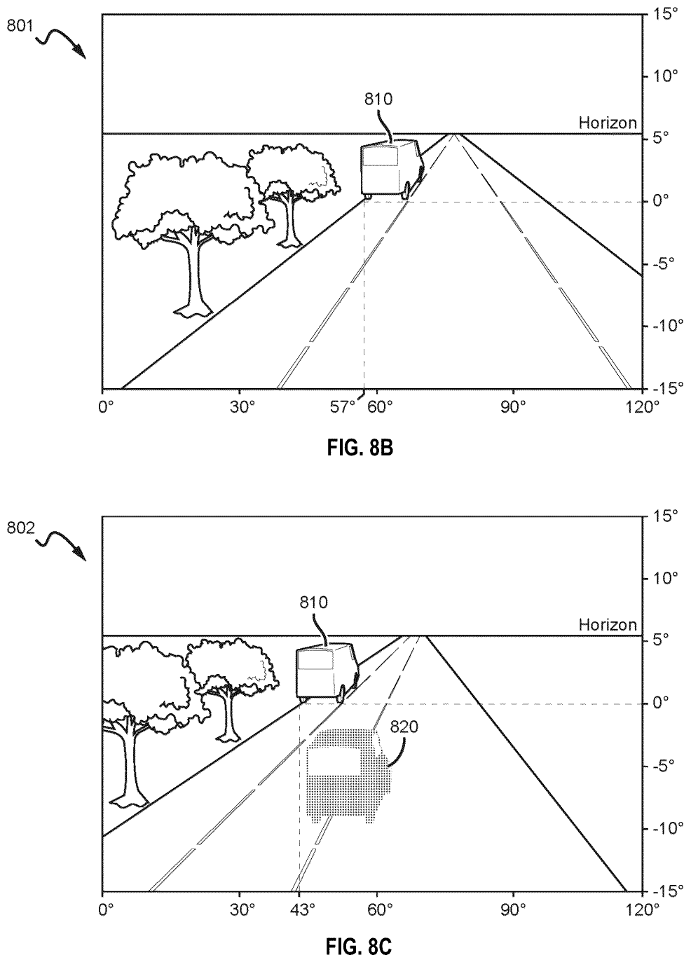

FIG. 8A illustrates a top view of two vehicles installed with LiDAR systems driving on a three-lane roadway according to one embodiment. Vehicle 811 is installed with LiDAR system 821 and is driving in the middle lane of the road. Vehicle 812 is installed with LiDAR system 822 and is driving in the right lane of the road. LiDAR system 822 is similar to LiDAR system 821. Vehicle 812 can have approximately the same height as vehicle 811 and is parallel with vehicle 811. In this embodiment, both LiDAR systems 821 and 822 are installed on the rooftop of their respective vehicles. As such, the two LiDAR systems are at approximately the same height relative to the road surface. In other embodiments, the LiDAR systems may be mounted on, or integrated to, their respective vehicle at other locations (e.g., rear-view mirrors, pillars, front grille, and/or back bumpers, etc.) A third vehicle 810 is driving in the left lane ahead of vehicles 811 and 812. From the perspective of vehicles 811 and 812, vehicle 810 is an external object and can be scanned and detected by the LiDAR systems installed on vehicles 811 and 812.

FIG. 8B illustrates LiDAR view 801 of a road scene perceived by vehicle 811 driving in the middle lane of a three-lane roadway according to one embodiment. LiDAR view 801 is a 3D point cloud view of the external environment perceived by LiDAR system 821. It should be understood that 3D point cloud views presented in this disclosure, such as FIGS. 8B and 8C, are simplified renderings of actual 3D point clouds of LiDAR systems. They are presented for the purpose of illustrating interference and the effect of interference. They do not, however, represent what the actual 3D point clouds of LiDAR systems would look like.

The angles displayed at the bottom of LiDAR view 801 represent horizontal angles of the FOV of system 811, spanning from 0° to 120°. This indicates that the FOV has a 120-degree horizontal range. The angles displayed to the right of LiDAR view 801 represent vertical angles of the FOV, spanning from −15° to 15°. This indicates that the FOV has a 30-degree vertical range. In other embodiments, the FOV of system 811 can have other horizontal and/or vertical ranges. For example, the FOV can have a 150-degree horizontal range and a 60-degree vertical range, or a 100-degree horizontal range and a 20-degree vertical range, etc.

As illustrated in FIG. 8B, vehicle 811 is driving in the middle lane of a three-lane roadway. Objects in LiDAR view 801 include the three-lane road, vehicle 810 driving in the left lane ahead, and additionally, two trees on the left side of the roadway.

FIG. 8C illustrates LiDAR view 802 of a road scene perceived by vehicle 812 driving in the right lane of a three-lane roadway according to one embodiment. Vehicle 812 is driving in parallel with vehicle 811 (not shown in the figure). LiDAR view 802 is a 3D point cloud view of the external environment perceived by LiDAR system 822. Since LiDAR system 822 is similar to LiDAR system 821, the horizontal and vertical FOV ranges of system 822 are the same as the FOV ranges of system 821. View 802 is captured at about the same time view 801 is captured.

Comparing the two LiDAR views, the same objects in view 801 also appear in view 802, such as the three-lane road and vehicle 810. The vertical coordinates of these objects remain approximately the same because the two LiDAR systems are situated at the same height. The vantage point of view 802, corresponding to the location of LiDAR system 821, is shifted horizontally to the right compared to view 801. Accordingly, objects of view 801 are displaced horizontally to the left in view 802. For example, one of the two trees on the left side of the roadway is partially obscured in view 802. Likewise, vehicle 810 is also shifted horizontally to the left. For illustration, the horizontal position of the vehicle's left rear tire may be changed from a horizontal degree of 57° in view 801 to 43° in view 802. The vertical degree of the tire remains unchanged.

A significant distinction between LiDAR views 801 and 802 is the appearance of interference object 820 in view 802, which is caused by interference from LiDAR system 821. For instance, object 810 forms the return light by scattering of light transmitted by LiDAR system 821. Such return light may be received by LiDAR system 822, thereby causing interference. In this particular embodiment, interference object 820 resembles the actual vehicle 810 and may appear closer and/or larger to vehicle 812. In other embodiments, interference object 820 may appear as random noise points scattered across a broader area of the point cloud with no particular shape. However, interference may not happen every time two LiDAR systems are scanning in the same direction. Interference may happen when the steering mechanisms and the light sources of the two LiDAR systems are synchronized. Interference may cause downstream processors and/or algorithms to render wrong perceptions and decisions, resulting in accidents.

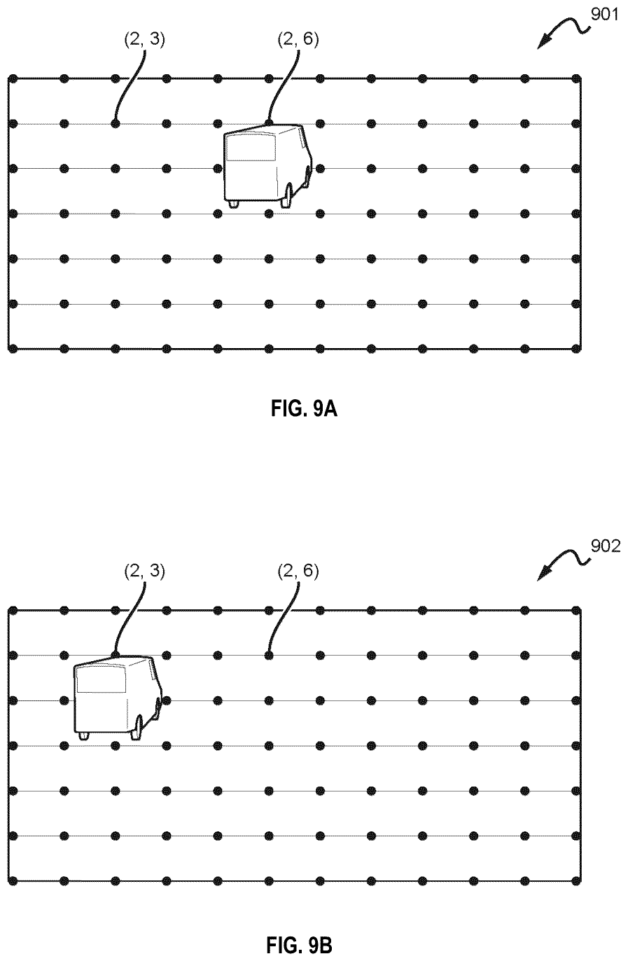

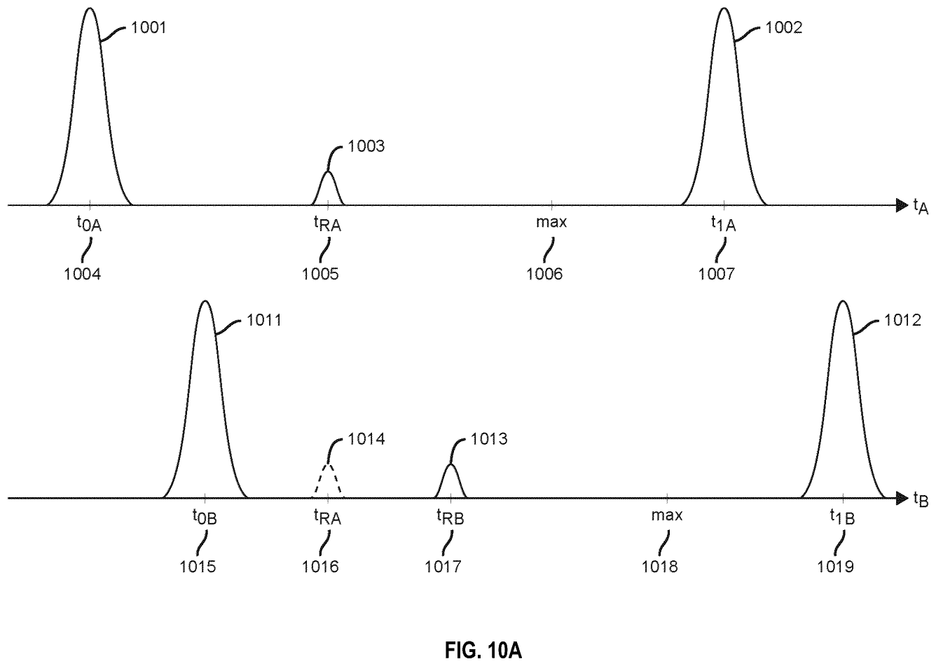

FIG. 9A illustrates a two-dimensional scan pattern scanned by the steering mechanism of LiDAR system 821 according to one embodiment. The scan is performed by, e.g., steering mechanism 340 illustrated in FIG. 3. In some embodiments, the steering mechanism may comprise, e.g., one or more polygon mirrors, including a variable angle multi-facet polygon mirror (VAMFP), one or more oscillating mirrors, one or more rotating prisms, one or more rotating tilt mirror surfaces, one or more single-plane or multi-plane mirrors, or a combination thereof. In this particular embodiment, the steering mechanism of LiDAR system 821 includes an oscillating mirror and a polygon mirror (not shown in the figure). The oscillating mirror scans in the vertical direction of the FOV, and the polygon mirror scans in the horizontal direction of the FOV.

The entire FOV of system 821 is scanned by completing one full cycle of the scan pattern. Each full scan cycle of the FOV produces a frame, denoted as frame 901. In FIG. 9A, frame 901 has seven horizontal scan lines. Each scan line has twelve scan positions (points). It should be understood that the number of scan lines and the number of points per each scan line depicted in FIG. 9A are for illustration purposes only. In reality, the actual numbers of scan lines and points in each scan line are significantly greater. Each point in frame 901 corresponds to a coordinate in the FOV. For example, the coordinate of the top left point is (1,1), and the coordinate of the bottom right point is (7, 12), etc. This coordinate of frame 901 may also be translated into the coordinate in horizontal and vertical angles of LiDAR view 801. For example, point (1, 1) in frame 901 can be translated to (0°, 15°) in view 801.

The steering mechanism of LiDAR system 821 is configured to scan the entire frame 901, also referred to as scan pattern 901. The scanning begins with the oscillating mirror moving to the first vertical position. The polygon mirror then scans the first horizontal line through rotation. Following this, the oscillating mirror moves to the next vertical position, and the next horizontal line is scanned by the polygon mirror. In one embodiment, upon the oscillating mirror's completion of one full cycle of movement from one end to the other, the LiDAR system achieves a full scan of one frame. In some embodiments, a full scan of one frame is achieved by combining a plurality of sub-frames scanned by one or more mirrors. In some embodiments, multiple light sources (e.g., providing multiple light beams) may be used such that one single revolution of the polygon mirror may produce multiple scan lines.

Each point in frame 901 corresponds to a set of movement positions of the mirrors in the steering mechanism. In this embodiment where there is an oscillating mirror and a polygon mirror, each point in frame 901 corresponds to a pair of movement positions of the oscillating mirror and the polygon mirror. The movement position of the polygon mirror can be expressed in azimuthal degree. In another embodiment where the steering mechanism includes a VAMFP, each point in frame 901 corresponds to a movement position of the VAMFP.

When scan pattern 901 is used by LiDAR system 821 to scan the external environment in FIG. 8B, objects in the external environment are detected by LiDAR system 821, and LiDAR view 801 is generated. To simplify the discussion, instead of showing all the objects of view 801 in frame 901, only vehicle 810 is shown in frame 901. In frame 901, vehicle 810 appears within the block between coordinates (2, 5) and (4, 7). The top of vehicle 810 is located at coordinate (2, 6).

FIG. 9B illustrates a two-dimensional scan pattern scanned by the steering mechanism of LiDAR system 822 according to one embodiment. Since LiDAR system 822 is similar to LiDAR system 821, scan pattern 902 is the same as scan pattern 901. When scan pattern 902 is used by LiDAR system 822 to scan the external environment in FIG. 8C, LiDAR view 802 is generated. To simplify the discussion, only vehicle 810 is shown in frame 902, which appears within the block between coordinates (2, 2) and (4, 4). The top of vehicle 810 is located at coordinate (2, 3). Compared to FIG. 9A, the top of vehicle 810 is shifted from (2, 6) to (2, 3). This corresponds to the fact that vehicle 810 is shifted from 57° to 43° horizontally between FIG. 8B and FIG. 8C.

Interference can start when LiDAR systems 821 and 822 simultaneously scan the same position of the same object in an external environment. With respect to LiDAR systems 821 and 822, the top of vehicle 810 is a position in the external environment. This position corresponds to point (2, 6) in frame 901, and point (2, 3) in frame 902. Interference may start at the moment when LiDAR system 821 is scanning point (2, 6) in frame 901, while LiDAR system 822 is scanning point (2, 3) in frame 902. Referring back to FIG. 7A, interference happens at the particular moment when scattered pulse 723, which is scattered from outgoing pulse 712 of LiDAR system 1, is received by LiDAR system 2 along path 723. On the other hand, if scattered pulse 723 is directed towards LiDAR system 2 along path 723, while LiDAR system 2 is not scanning along path 723 at that moment, interference will not happen. This is because pulse 723 cannot be received by LiDAR system 2.

After the interference started, it can continue when the steering mechanisms of the two LiDAR systems continue to be synchronized, which means that the two LiDAR systems continue to simultaneously scan, along their respective scan patterns, subsequent positions in the external environment in the same manner. Two steering mechanisms may be synchronized when, after the interference started, the mirrors of the two steering mechanisms move at the same speed, and the two LiDAR views at least partially overlap with respect to the external environment.

Referring still to FIGS. 9A and 9B, when the steering mechanisms of the two systems 821 and 822 are synchronized and are scanning line 2 of their respective frames 901 and 902, system 821 always scans three points ahead of system 822. That is, when system 821 scans point (2, 6) in frame 901, system 822 is scanning point (2, 3) in frame 902. When system 821 moves to (2, 7) in frame 901, system 822 would move to point (2, 4) in frame 902. Therefore, the next interference point happens at point (2, 4) in frame 902, and so on. When the two steering mechanisms move to scan the next scan line (e.g., line 3), interference will again happen at point (3, 3), (3, 4), and so on, in frame 902. If the two steering mechanisms continue to scan in this manner, a continued interference may occur.

Continued interference may result when the mirrors of two steering mechanisms move at the same speed. Each point in frames 901 and 902 corresponds to a pair of movement positions of the oscillating mirror and the polygon mirror in the steering mechanism. If the mirrors of the two LiDAR systems move at the same speed, they can always simultaneously scan same points in the external environment, line after line, and frame after frame. If there are objects at the scanned points, a large area of noise points or false objects may appear in the point cloud of the affected LiDAR system. In this case, the affected LiDAR system is system 822 and the false object is the interference object 820 in FIG. 8C. On the other hand, if the mirrors of the two LiDAR systems move at different speeds, the two steering mechanisms would be out of synchronization very soon after a certain number of points are scanned.

Sometimes, when an external object's relative position in the frames changes, the synchronization of the two steering mechanisms of systems 821 and 822 with respect to the location of that external object may be lost. In that case, interference may disappear. For example, if vehicle 810 slows down in the left lane, the top point of vehicle may move from point (2, 6) to point (4, 4) in frame 901, but the same point may move from (2, 3) to point (5, 1) in frame 902. Consequently, the two steering mechanisms are no longer synchronized with respect to vehicle 810. When system 822 is scanning point (5, 1) in frame 902 (where the top of vehicle 810 is), system 821 is scanning point (5, 4) in frame 901, because system 821 always scans three points ahead of system 822 in their respective frames. However, there may not be an external object at point (5, 4) in frame 901. As a result, no scattered pulse will be generated and received by system 822. The interference object associated with vehicle 810, e.g., interference object 820, disappears.

As previously explained, synchronization of the steering mechanisms of two LiDAR systems may cause interference. In addition, for interference to occur, the timing of the laser pulses of the two light sources in the two LiDAR systems also need to be synchronized.

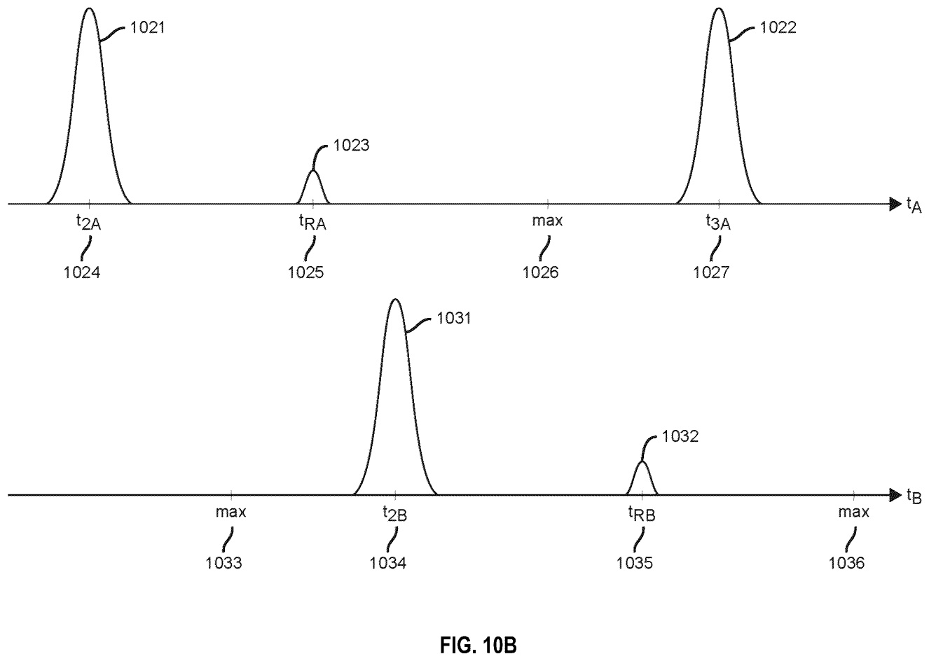

FIG. 10A illustrates two timing diagrams showing light pulses transmitted and received by two LiDAR systems when their light sources are synchronized according to one embodiment. The top diagram of FIG. 10A is a section of the pulse timing diagram of LiDAR system 821. The horizontal axis (t_{A}) is the time axis representing the lapse of time. Pulses 1001 and 1002 are two consecutive outgoing light pulses transmitted by the light source of system 821. The light source of system 821 can be implemented by, e.g., light source 310 of LiDAR system 300 in FIG. 3. Pulse 1001 is transmitted at time t_{0A} (reference 1004). Pulse 1002 is transmitted at time t_{1A} (reference 1007).

A “firing cycle” is referred to as the time period between two consecutive outgoing light pulses transmitted by the light source. For example, the period between t_{0A} and t_{1A} is one firing cycle of LiDAR system 821. Timings t_{0A} and t_{1A} are also referred to as “triggers”. During each firing cycle, the steering mechanism scans at different scan positions according to the scan pattern. For example, referring back to FIG. 9A, during the first firing cycle (between pulse 1001 and 1002 in FIG. 10A), the steering mechanism of system 821 could be scanning at point (2, 6). Then, at the next firing cycle, the steering mechanism would be scanning at point (2, 7).

Referring still to FIG. 10A, when outgoing pulse 1001 hits an object, e.g., object 703 in FIG. 7A, or vehicle 810 in FIGS. 8B and 8C, scattered pulse 1003 is generated and received by the light detector of LiDAR system 821. The light detector of system 821 can be implemented by, e.g., optical receiver and light detector 330 of LiDAR system 300 in FIG. 3. Pulse 1003 is received at time t_{RA} (reference 1005). Based on this time-of-flight information (from t_{0A} to t_{RA}), LiDAR system 821 can determine the distance to object by multiplying the time-of-flight and the speed of light, and then dividing the multiplication result by 2.

Reference 1006 (“max”) indicates the maximum timing within a firing cycle that the LiDAR system may detect a return pulse. The distance that light can travel in one nanosecond is approximately 0.3 meters. As an example, for a LiDAR system that can detect objects at maximum 90 meters away, the maximum roundtrip travel time of light pulse would be approximately 600 ns. Therefore, the “max” timing position (1006) would be 600 ns from t_{0A}. The time window between the start of a firing cycle, e.g., t_{0A} (1004) and the maximum roundtrip time of detectable light pulse, e.g., “max” timing position (1006), is referred to as the “detection window.” In some embodiments, the LiDAR system only detects return pulses within the detection window. The system does not detect return pulses beyond the detection window, i.e., between “max” timing position (1006) and the start of the next firing cycle (1007). In other embodiments, there is no detection window. The LiDAR system detects return pulses during the entire firing cycle.

The bottom diagram of FIG. 10A is a section of the pulse timing diagram of LiDAR system 822. The horizontal axis (t_{B}) is the time axis representing the lapse of time. Pulses 1011 and 1012 are two consecutive outgoing light pulses transmitted by the light source of system 822. Pulse 1011 is transmitted at time t_{0B} (reference 1015). Pulse 1012 is transmitted at time tiB (reference 1019). Because the two systems 821 and 822 are similar, the firing cycles between the top and the bottom diagrams are the same.

Pulse 1013 represents a return pulse scattered by the same object hit by pulse 1001 of system 821. That same object can be object 703 in FIG. 7A, or vehicle 810 in FIGS. 8B and 8C. Scattered pulse 1013 is then received by the light detector of LiDAR system 822 at time t_{RB} (reference 1017). Reference 1018 (“max”) represents the maximum range of the detection window, which is between t_{0B} (1015) and “max” (1018).

The two diagrams of FIG. 10A are plotted in the same time domain, or in other words, they share the same clock. Therefore, the sequence of events depicted by FIG. 10A is as follows. First, pulse 1001 is transmitted by system 821 at time t_{0A}. Then, pulse 1011 is transmitted by system 822 at time t_{0B}. After that, scattered pulse 1003 is received by system 821 at time t_{RA} (reference 1005). Also at time t_{RA}, pulse 1014 (the interference pulse) is received by system 822. Next, scattered pulse 1013 is received by system 822 at time t_{RB}. Subsequently, the next outgoing pulse 1002 is transmitted by system 821, followed by the next outgoing pulse 1012 transmitted by system 822.

The firing cycles of the two LiDAR systems substantially overlap in FIG. 10A. If during the two overlapped firing cycles the steering mechanisms of the two LiDAR systems happen to scan towards the same position of the same object in the external environment, such as vehicle 810 in FIGS. 8B and 8C, interference may occur. For example, at time t_{RA} (reference 1005 in the top diagram), system 821 receives scattered pulse 1003 scattered by an object. At the same time (reference 1016 in the bottom diagram), scattered pulse 1014 is formed by the same object. Pulse 1014 is then received by system 822 during the detection window and is deemed a valid return. In this case, pulse 1014 becomes an interfering pulse. A point in the scan pattern 902 of FIG. 9B corresponding to the firing cycle (between pulses 1011 and 1012) may appear as an interference point or noise in the point cloud of LiDAR system 822.

When more points of the same object are being scanned in this manner, a large area of noise points or false objects, such as interference object 820 in FIG. 8C, may appear in the affected LiDAR system's point cloud. Referring to FIG. 8C together with FIG. 10A, because interference pulses are scattered by vehicle 810, false object 820 resembles the actual vehicle 810. However, it is not a real object. In addition, false object 820 may appear closer to LiDAR system 822 than vehicle 810. This is because time t_{RA} (reference 1016) comes earlier than time t_{RB} (reference 1017). The correct distance to vehicle 810 should be calculated based on the time-of-flight between time t_{0B} (reference 1015) and time t_{RB} (reference 1017). However, since pulse 1014 may be deemed as a valid return, a shorter distance calculated between time t_{0B} (reference 1015) and time t_{RA} (reference 1016) may be used to display the location of points in LiDAR view 802. As a result, false object 820 may appear closer and larger than vehicle 810.

FIG. 10A indicates that after an outgoing pulse (pulse 1011) is transmitted, more than one return pulses (pulses 1014 and 1013) may be detected by the light detector. When multiple return pulses are detected, the control circuitry of the LiDAR system, e.g., control circuitry 350 of FIG. 3, may use various algorithms to determine which pulse is the valid return. For example, the control circuitry may pick the return pulse with higher intensity. Intensity of a pulse is referred to as the sum of the sampled amplitude value of the signal waveform at each sampled position. In other examples, the control circuitry may pick an earlier return pulse, or a later return pulse. The determination may be made in each firing cycle. Consequently, in one firing cycle, an earlier return pulse (representing a point in the false object 820) may be picked if the earlier pulse shows a higher intensity. In the next firing cycle, a later pulse (representing a point on vehicle 810) may be picked if the later pulse has a higher intensity. The outcome of this selection may appear to be random, as the relative intensity between pulses 1013 and 1014 (indicating which pulse's intensity is higher) may be randomly distributed. Therefore, in LiDAR view 802 of FIG. 8C, when there is interference, vehicle 810 may be represented by fewer points and false object 820 is formed by discrete points that collectively may resemble vehicle 810. In some cases, because of the randomness of selection, the discrete points may not resemble vehicle 810, but may appear as a large area of random noise points.

Referring FIG. 7A together with FIG. 10A, pulse 1001 is the same as the outgoing light pulse 712. Pulse 1003 is the same as the first scattered pulse 714, and pulse 1014 is the same as the second scattered pulse 724. FIG. 10A illustrates that in addition to the steering mechanisms being synchronized, for interference to occur, the two light sources of the two LiDAR systems also need to be synchronized. This means that the scattered pulse of the first LiDAR system (pulse 1003) should be received by the second LiDAR system (as pulse 1014) during its detection window. If the scattered pulse falls outside of the detection window of the second LiDAR, interference may not happen.

FIG. 10B illustrates two timing diagrams showing the light pulses transmitted and received by two LiDAR systems when their light sources are not synchronized according to one embodiment. FIG. 10B is similar to FIG. 10A, except that it shows the firing cycles of the two LiDAR systems at a different time. The top diagram of FIG. 10B is a section of the pulse timing diagram of LiDAR system 821 showing pulses transmitted and received during another firing cycle (between pulses 1021 and 1022). The bottom diagram of FIG. 10B is a section of the pulse timing diagram of LiDAR system 822. Due to the limited scope of the diagram, only one transmitted pulse 1031 is shown. Two partial firing cycles are situated on both sides of pulse 1031. Similar to FIG. 10A, the two diagrams of FIG. 10B are plotted in the same time domain.

As illustrated in FIG. 10B, the two LiDAR systems 821 and 822 can be de-synchronized such that the scattered pulse of LiDAR system 821 (pulse 1023) falls between the end of detection window of the previous firing cycle (1033) and the start of the next firing cycle t_{2B} (1034) of LiDAR system 822. Therefore, it falls outside of the detection window of system 822. Interference does not occur in this situation because the scattered pulse 821 will not be detected by the light detector of system 822.

Since interference may happen when the steering mechanisms and the light sources of two LiDAR systems are synchronized, interference may be reduced or eliminated by de-synchronizing either the steering mechanisms, or the light sources of the two LiDAR systems, or both. To de-synchronize the two light sources, timing difference between the start of two closest firing cycles, e.g., the difference between t_{0A} (1004) and t_{0B} (1015) in FIG. 10A, can be adjusted so that pulse 1003 falls outside of the detection window of system 822. This is the situation depicted in FIG. 10B. However, in the embodiment where there is no detection window (return pulses are detected during the entire firing cycle), adjusting the timing difference between the two firing cycles of the two LiDAR system may not de-synchronize the two light sources.

Interference can also be reduced or eliminated by de-synchronizing the steering mechanisms of the two LiDAR systems. As previously explained, the steering mechanisms of two LiDAR systems may be synchronized when, after the interference started, the mirrors of the two steering mechanisms move at the same speed. To de-synchronize the two steering mechanisms, the moving speed of, e.g., the polygon mirror, of one steering mechanism may be increased or decreased to a certain extent. Because the moving speed of mirrors may affect the point cloud's resolution, the speed may return to normal after a certain period of time. This period should be long enough to adjust the time offset between the two scan patterns of the two LiDAR system, so that interference will not start. Time offset between the two LiDAR systems, also referred to as “time delay” in this disclosure, is the time difference between when the first LiDAR system scans point (1, 1) in its own scan pattern, and when the second LiDAR system scans point (1, 1) in its own scan pattern. Additionally, “position offset” is referred to as the difference in coordinates between the two points scanned at the same time by the two LiDAR systems. For example, when one LiDAR system scans (2, 6) while the other system scans (2, 3), the position offset between the two systems is 3 points. Time offset between the two LiDAR systems can also be viewed as the time it takes for the polygon mirror to scan the number of position offsets in a frame.

Referring back to FIGS. 9A and 9B, interference may start when LiDAR systems 821 and 822 simultaneously scan the same position of the same object in an external environment. For example, interference may start when system 821 is scanning point (2, 6) in frame 901, while system 822 is scanning point (2, 3) in frame 902. In this case, the position offset is 3. If the position offset is adjusted to 2 points, then when system 821 is scanning point (2, 6) in frame 901, system 822 would be scanning point (2, 4) in frame 902. The two points are no longer on the same position of the same object. As a result, interference will not start.

In the above example, interference may start when the position offset is 3, but may not start when the position offset is 2. Therefore, adjusting the position offset, or the corresponding time delay between the two LiDAR systems may disrupt the initial occurrence of interference. In other examples, the position offset may be adjusted higher to avoid interference. For example, position offset may be adjusted to 5, so that when system 821 is scanning point (2, 6) in frame 901, system 822 is scanning point (2, 1) in frame 902. Position offset may be adjusted by changing the movement speed of mirrors (polygon and/or oscillating mirror) in one or both LiDAR systems.

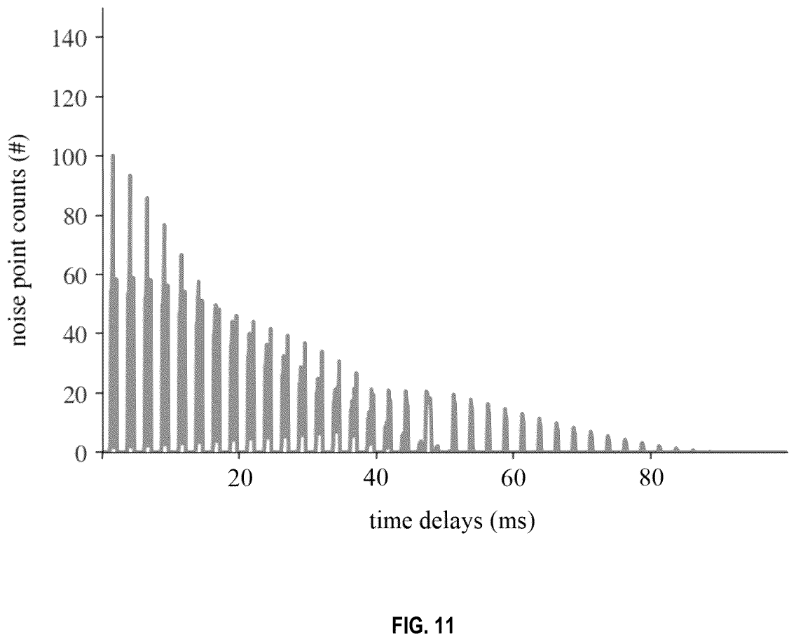

FIG. 11 illustrates a plot demonstrating the correlation between the occurrence of interference points in a frame and the time delays between two LiDAR systems according to one embodiment. The horizontal axis represents time delays in milliseconds between the two LiDAR systems. The vertical axis represents the count of noise (interference) points in the affected LiDAR system under various time delays. In this embodiment, the two LiDAR systems are similar. Assuming that a polygon mirror rotates at 4,800 rpm (revolutions per minute), it would take 12.5 milliseconds (ms) for the polygon mirror to rotate one revolution. If the polygon mirror has 5 facets, it would take 2.5 ms for one facet to scan one scan line in the scan pattern. Accordingly, when the time delay between the two LiDAR systems is 2.5 ms, the position offset between the two LiDAR systems is one scan line. When the time delay is 5 ms, the position offset is two scan lines, and so forth. In other embodiments, the amount of time for the polygon mirror to scan one scan line may be different than 2.5 ms, because the rotation speed of the polygon mirror, the number of facets, or the number of mirrors, etc., may be different from this embodiment.

FIG. 11 indicates that the waveform of the number of interference points fluctuates while the time delay between the two LiDAR system increases. In this embodiment, the waveform fluctuates periodically when the time delay increases every 2.5 ms. An additional 2.5 ms of time delay means that position offset between the two LiDAR systems is off one entire scan line. Referring back to FIGS. 9A and 9B, the position offset between systems 821 and 822 is 3. Interference occurs when LiDAR system 821 is scanning point (2, 6) in frame 901, while LiDAR system 822 is scanning point (2, 3) in frame 902. When adding an additional time delay of 2.5 ms, the position offset would become 3+12=15 (one scan line has 12 points). This means that when system 822 is scanning point (2, 3) in view 902, system 821 is scanning point (3, 6), instead of point (2, 6), in view 901. As the scan lines in these figures are for illustration purpose only, in reality, point (3, 6) would be very close to point (2, 6). Therefore, if point (2, 6) can cause interference, point (3, 6) may also cause interference in a similar manner, except that the interference may be of a less degree than point (2, 6). Similarly, point (4, 6) may also cause an interference. Thus, the waveform of the number of interference points repeats periodically every 2.5 ms. The number decreases as the time delay increases, until the interference may disappear when the position offset between the two LiDAR systems is too far apart.

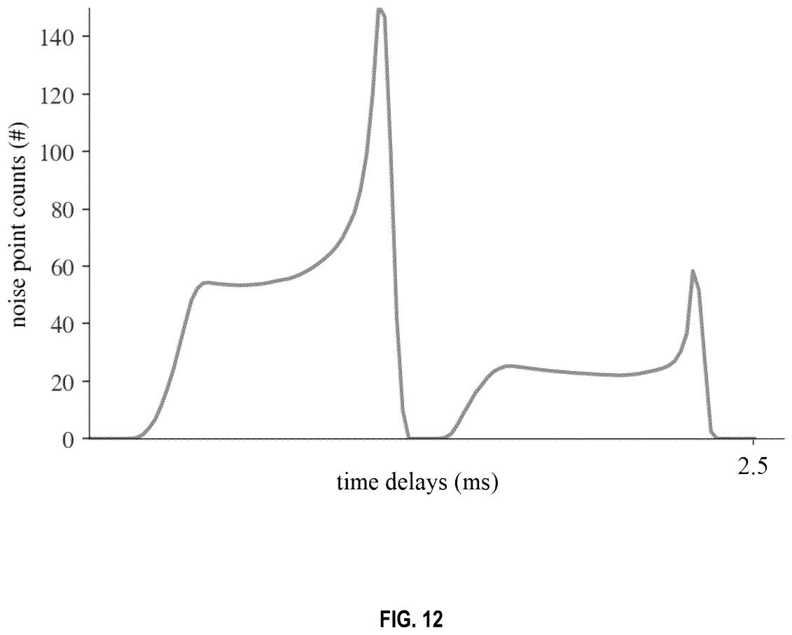

FIG. 12 illustrates a close-up view of FIG. 11 when the time delay is within a 2.5 milliseconds range according to one embodiment. The horizontal axis represents time delays in milliseconds between the two LiDAR systems. The vertical axis represents the count of noise (interference) points in the affected LiDAR system under various time delays. In this embodiment, within the 2.5 ms time delay, the waveform of the count of interference point reaches its zenith at the figure's midpoint. Subsequently, it declines to hit a minimum in approximately 0.4 ms. This suggests that if the interference in the affected LiDAR system peaks, introducing an additional time delay of 0.4 ms to the scan pattern can effectively reduce the interference. In some embodiments, the interference reaches its peak when the count of interference points exceeds a threshold value, e.g., 120. When the count of noise points in a frame exceeds the threshold value, adding an extra time delay of 0.4 ms would reduce the interference.

It should be understood that the waveform depicted in FIGS. 11 and 12 might vary in different LiDAR systems. The correlation between the number of interference points and time delays may be influenced by several factors, such as the external environment, the configuration of mirrors in the steering mechanisms, the similarity between the two LiDAR systems, among others.

FIG. 13 is a flowchart illustrating a method for reducing interference in a LiDAR system according to one embodiment. Method 1300 may be performed by LiDAR system 300 illustrated in FIG. 3, LiDAR system 500 illustrated in FIG. 5, LiDAR systems 701 and 702 illustrated in FIG. 7A, and LiDAR systems 821 and 822 illustrated in FIGS. 8A, 8B, 8C, 9A, 9B, 10A and 10B.

Method 1300 includes step 1310, in which a LiDAR system receives noise by a light detector of the LiDAR system. Noise signals, along with actual return signals, may be received by, e.g., light detector of LiDAR system 822. When noise signals are received by a LiDAR system, they may appear as noise points in the point cloud. Noise points do not represent actual returns from external objects. However, they are mixed with the “good” points in the point cloud that do represent actual returns from external objects.

In FIG. 10A, an example noise pulse 1014 is received by LiDAR system 822. At time t_{RA} (reference 1005), LiDAR system 821 receives scattered pulse 1003, which is scattered by an object in the external environment. At the same time (reference 1016), scattered pulse 1014 is formed by the same object and received by system 822. Pulse 1014 is therefore an interference (or noise) pulse. A point corresponding to noise pulse 1014 may appear in the point cloud of LiDAR system 822 as noise point.

In FIG. 8C, when multiple noise signals are received by the LiDAR system in this manner, a large area of noise points or false objects, e.g., false object 820 may appear in the point cloud. As previously explained, object 820 may resemble the actual vehicle 810. Sometimes, noise may appear as random points in a larger area of the point cloud with no particular shape.

Although noises are mixed with good points in the point cloud, a LiDAR system may distinguish between noise and actual returns in several ways. For example, a LiDAR system may use object classifier 223 of FIG. 2 to classify objects in the point cloud, so that noise may be distinguished from classified objects, such as pedestrians, buildings, and cars. In another example, an area of random points may always appear at fixed positions in the point cloud during vehicle movement. The LiDAR system can identify and classify these points as noise, because real-world objects would not consistently exhibit such patterns by continually following the vehicle at a fixed distance.

Noise may be reduced by LiDAR systems in various stages. In some embodiments, a LiDAR system removes noise signals after the noise is detected. For example, a LiDAR system may first capture both noise and regular returns within the point cloud. Then, the LiDAR system distinguishes and identifies noise from the regular returns. Next, the LiDAR system removes the identified noise from the point cloud. This is a post-hoc approach and involves the LiDAR system awaiting the occurrence of noise before taking a remedial action.

In other embodiments, upon the first detection of noise, the LiDAR system determines the cause of the noise and attempts to reduce the noise by addressing its root cause. For example, when interference noise emerges, the LiDAR system may first ascertain whether the noise is indeed interference-related. If confirmed, the LiDAR system may then desynchronize it from the other LiDAR systems that cause the interference. In this way, the LiDAR system may prevent more interference from happening.

In yet other embodiments, a LiDAR system may avoid interference even before it first occurs. For example, in scenarios where multiple LiDAR systems operate close by on different vehicles, the operational characteristics of each LiDAR system's steering mechanisms, such as mirror rotational speed and scan patterns, may be shared with other LiDAR systems via communication paths 251 and/or 253 in FIG. 2. Based on the information regarding the operational characteristics of the neighboring LiDAR systems and the external environment, the LiDAR system may adjust its own operational characteristics to preemptively avoid interference. Additionally, the LiDAR system may communicate with the other LiDAR systems and inform them to adjust their operational characteristics to prevent interference.

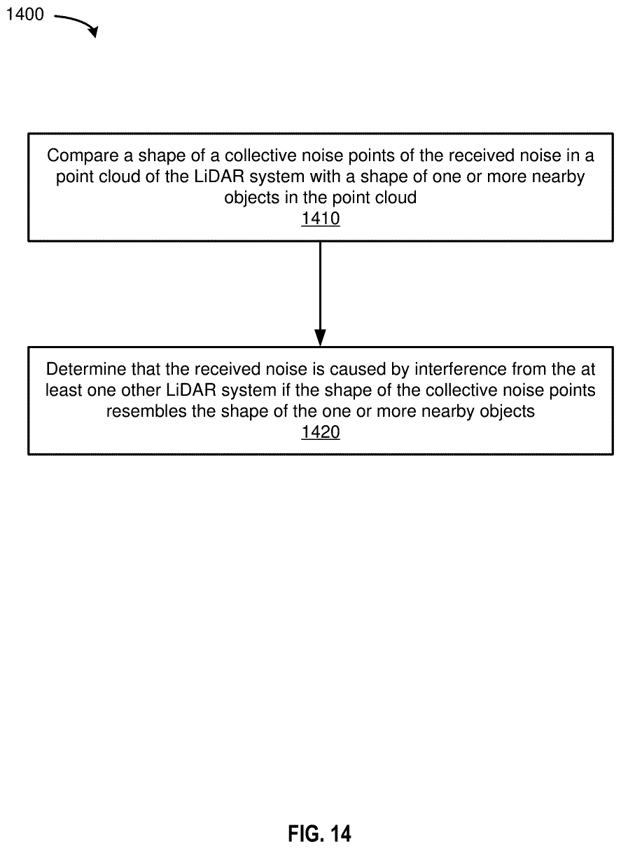

Method 1300 further includes step 1320, in which the LiDAR system determines whether the received noise is caused by interference from other LiDAR system(s). When noise points emerge in point cloud, they may be caused by interference from other LiDAR systems, or they may be caused by other types of noises, such as environmental noise. The LiDAR system may employ various methods to determine whether the received noise is caused by interference as further described in FIGS. 14-17.

Method 1300 further includes step 1330, in which in accordance with a determination that the detected noise is caused by interference from other LiDAR system(s), de-synchronizes the LiDAR system with the other LiDAR system(s). As previously explained, since interference may happen when the steering mechanisms and the light sources of two LiDAR systems are synchronized, interference may be reduced or eliminated by de-synchronizing either the steering mechanisms, or the light sources of the two LiDAR systems, or both.

In some embodiments, de-synchronizing the light sources of two LiDAR systems may include adjusting timings of firing cycles of the LiDAR system such that scattered pulses formed based on transmission light from the other LiDAR system(s) fall outside of detection windows of the LiDAR system. As previously explained in FIG. 10A, to de-synchronize the two light sources, timing difference between the start of two closest firing cycles, e.g., the difference between t_{0A} (1004) and t_{0B} (1015), can be adjusted so that pulse 1003 falls outside of the detection window of system 822, which is the situation depicted in FIG. 10B (pulse 1023). In reality, because system 822 may not know the timing of the firing cycles of system 821, system 822 may adjust the timing of it own firing cycles so that pulse 1003 falls outside of the detection window of LiDAR system 822.

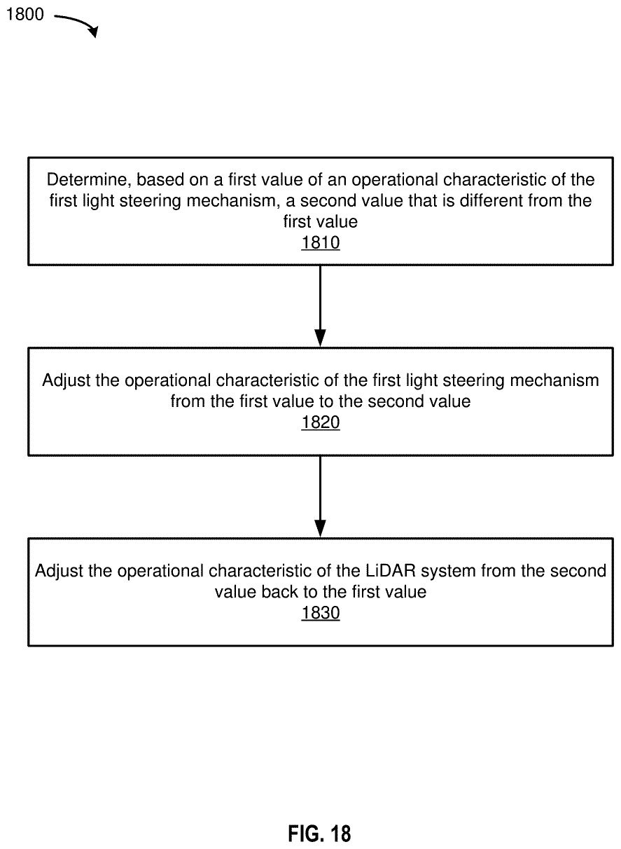

Methods for de-synchronizing the steering mechanism of two LiDAR systems are further illustrated in FIG. 18.

In some embodiments, after the affected LiDAR system (system 822) determines that the noise is caused by interference from system 821, it may inform the determination to system 821 via communication paths 251 and/or 253. System 821 may proactively adjust its rotational speed to prevent interference. In another embodiment, both systems may coordinate the process of speed change of their respective polygon mirrors. For example, one LiDAR system may accelerate the polygon mirror, while the other LiDAR system decelerates the mirror, or vice versa. In this way, interference may be avoided more quickly.

In some embodiments, operational characteristics include the rotation speed of polygon mirrors, the movement speed of oscillating mirrors, or both. Position offset may be adjusted by changing the movement speed of the oscillating mirror in one or both LiDAR systems. Because the speed of oscillating mirror may affect vertical resolution, the speed should return to normal after a short period of time. In some embodiments, to maintain the same frame rate, the oscillating mirror may, within one frame, move faster in some vertical regions, and move slower in some other vertical regions. In this approach, the full cycle of the oscillating mirror, referred to as the time it takes to traverse from one end to the other, remains constant even if the speed varies throughout the cycle.

In some embodiments, de-synchronizing the two steering mechanisms of two LiDAR system may include adjusting a scan pattern of the LiDAR system to introduce or modify one or more regions of interest (ROIs) in a field-of-view of the LiDAR system. A LiDAR system's scan pattern may include one or more ROIs in an FOV. A region of interest may occupy a particular portion of the FOV that requires additional data or scanning resolution compared to regions that are not of interest. Region of interest is described in more detail in U.S. non-provisional patent application Ser. No. 16/439,230, filed Jun. 12, 2019, entitled “LiDAR Systems And Methods For Focusing On Ranges of Interest”, the content of which is incorporated by reference in it is entirety for all purposes. In a LiDAR system that employs ROI functionality, an increase in vertical resolution of an ROI may be achieved by slowing down the speed of the oscillating mirror when ROI is being scanned. An increase in horizontal resolution may be achieved by increasing the time interval of successive outgoing pulses when the ROI is being scanned. Therefore, introducing or modifying one or more ROIs in an FOV of one LiDAR system may de-synchronize the two LiDAR systems and disrupt the interference.

In some embodiments, de-synchronizing two LiDAR systems may include rotating a housing of one LiDAR system to change a field-of-view of the LiDAR system. Interference may disappear when an external object's relative position changes in the respective frames of the two LiDAR systems. For example, in FIGS. 8B and 8C, interference object 820 may disappear if vehicle 810 slows down, i.e., moves towards to the bottom left corner of frame 802. In some embodiments, the same effect may be achieved by rotating the housing of LiDAR system 822 installed on vehicle 812, thereby changing the FOV system 822.

In some embodiments, when two LiDAR systems are synchronized and interference occurs in one LiDAR system, the other LiDAR system may also experience interference. For example, referring to FIG. 10A, pulses 1014 and 1003 are scattered by vehicle 810 from outgoing pulse 1001. Pulse 1014 causes interference on system 822. Around the same time, pulse 1013 and another scattered pulse (not shown in the figure) may be scattered by the same position on vehicle 810 from outgoing pulse 1011. This other scattered pulse happens at the same time as timing 1017 but appears on the t_{A} axis, and can be received by system 821 because the two systems are both scanning towards the same position at this time. When two LiDAR systems are aware that interference is occurring, they may inform each other and reduce interference in a coordinated manner. In some embodiments, when interference starts to occur, one LiDAR system may choose not to reduce interference and wait for the other LiDAR system to reduce interference first.

FIG. 14 is a flowchart illustrating a method for determining whether the received noise is caused by interference from other LiDAR systems according to one embodiment. Method 1400 may be performed by LiDAR system 300 illustrated in FIG. 3, LiDAR system 500 illustrated in FIG. 5, LiDAR systems 701 and 702 illustrated in FIG. 7A, and LiDAR systems 821 and 822 illustrated in FIGS. 8A, 8B, 8C, 9A, 9B, 10A and 10B.

Method 1400 includes steps 1410 and 1420. In step 1410, a LiDAR system compares the shape of a collective noise points of the received noise in a point cloud of the LiDAR system with the shape of one or more nearby objects in the point cloud. In step 1420, the LiDAR system determines that the received noise is caused by interference from the other LiDAR system(s) if the shape of the collective noise points resembles the shape of the one or more nearby objects.

A LIDAR system may determine if the noise is caused by interference based on the shape of the noise points. As illustrated in FIG. 8C and FIG. 10A, false object 820 is noise caused by interference. The LiDAR system may determine that object 820 is caused by interference by comparing the shape and/or the size of object 820 with one or more nearby objects. As previously explained, even when there is interference, vehicle 810 does not disappear, and false object 820 may be formed by discrete points that collectively mimic vehicle 810. In this scenario, the shape of object 820 resembles the actual vehicle 810, and may appear closer and larger to LiDAR system 822. This is because of the earlier reception of interference pulse 1014 compared to the actual return pulse 1013. In another embodiment, pulse 1001 may start later than pulse 1011, resulting in the delayed reception of interference pulse 1014 relative to pulse 1013. In that scenario, the collective noise points may also resemble vehicle 810, but may appear smaller and more distant than the actual vehicle 810.

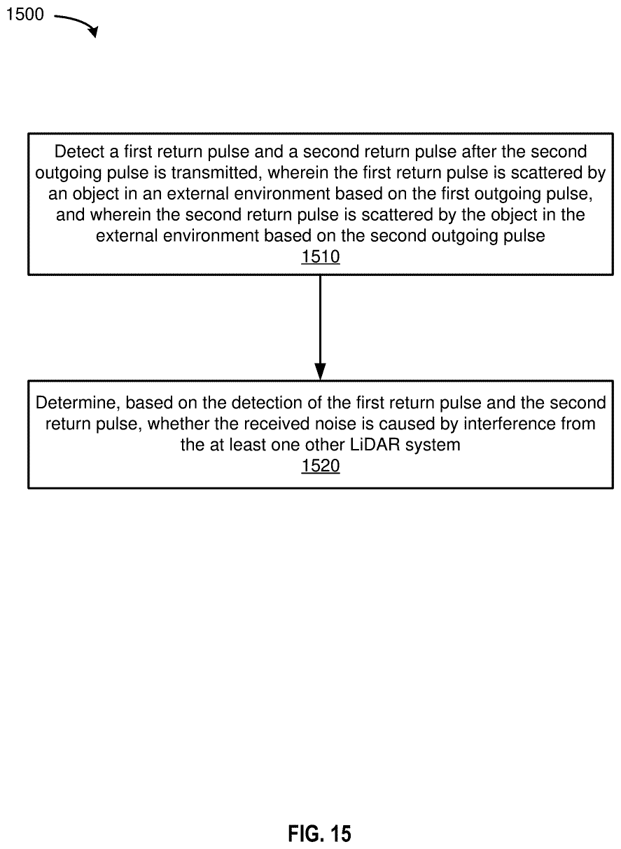

FIG. 15 is a flowchart illustrating a second method for determining whether the received noise is caused by interference from other LiDAR systems according to one embodiment. Method 1500 may be performed by LiDAR system 300 illustrated in FIG. 3, LiDAR system 500 illustrated in FIG. 5, LiDAR systems 701 and 702 illustrated in FIG. 7A, and LiDAR systems 821 and 822 illustrated in FIGS. 8A, 8B, 8C, 9A, 9B, 10A and 10B.

Method 1500 includes steps 1510 and 1520. In step 1510, a LiDAR system detects a first return pulse and a second return pulse after the second outgoing pulse is transmitted. Here, the first return pulse is scattered by an object in an external environment based on the first outgoing pulse. The second return pulse is scattered by the object in the external environment based on the second outgoing pulse. In step 1520, the LiDAR system determines, based on the detection of the first return pulse and the second return pulse, whether the received noise is caused by interference from the other LiDAR system(s). In this method, the first outgoing pulse is transmitted by the other LiDAR system(s), and the second outgoing pulse is transmitted by the LiDAR system.

A LIDAR system may determine if the noise is caused by interference based on the occurrence of double return pulses. As previously explained in FIG. 10A, interference occurs when, following a single outgoing pulse 1011, two return pulses (1013 and 1014) are received by the light detector instead of one. When this pattern continues to occur for a series of points, the LiDAR system may determine that the noise associated with the double pulses is caused by interference. Furthermore, the timing difference between outgoing pulse 1011 and the interference pulse 1014 (the time lapse between timing 1015 and 1016) may remain substantially constant over a time period. This is likely caused by two factors. First, the timing difference between the two firing cycles (the difference between 1004 and 1015) remains constant once the two LiDAR systems are synchronized. Second, the distance between LiDAR system 821 and vehicle 810, represented by the timing difference between 1004 and 1005, may also remain constant for a period of time. Therefore, the difference between timing 1015 and 1005/1016 may also remain constant. The LiDAR system may determine that the noise is caused by interference when the return timing of at least one pulse of the double return pulses remains substantially constant for a certain time period.

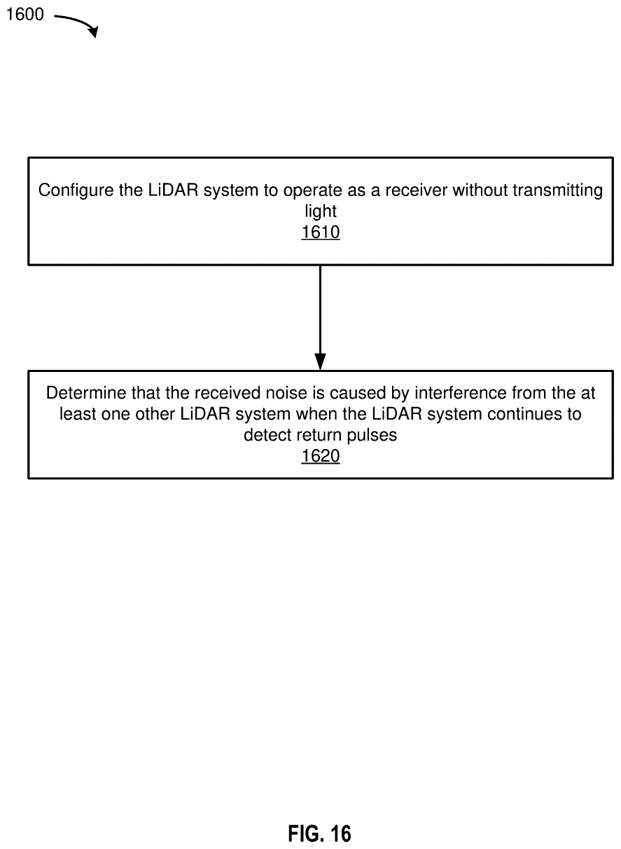

FIG. 16 is a flowchart illustrating a third method for determining whether the received noise is caused by interference from other LiDAR systems according to one embodiment. Method 1600 may be performed by LiDAR system 300 illustrated in FIG. 3, LiDAR system 500 illustrated in FIG. 5, LiDAR systems 701 and 702 illustrated in FIG. 7A, and LiDAR systems 821 and 822 illustrated in FIGS. 8A, 8B, 8C, 9A, 9B, 10A and 10B.

Method 1600 includes steps 1610 and 1620. In step 1610, a LiDAR system configures a LiDAR system to operate as a receiver without transmitting light. In step 1620, the LiDAR system determines that the received noise is caused by interference from the other LiDAR system(s) when the LiDAR system continues to detect return pulses.

In this embodiment, the LiDAR system may determine if the noise is caused by interference by temporarily halting the transmission of outgoing pulse, while continuing to detect return pulses. To ensure the ongoing safety of LiDAR operations, this transmission interruption may last for a short period, e.g., one or two frames. In the absence of transmitted outgoing pulses, if points continue to appear in the point cloud, it can be determined that these points are noise caused by interference from other LiDAR systems.

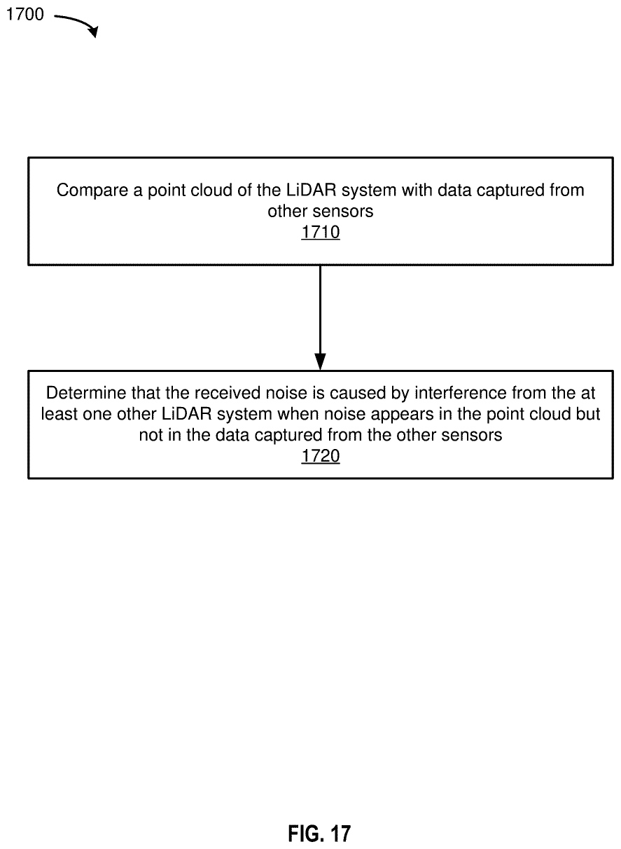

FIG. 17 is a flowchart illustrating a fourth method for determining whether the received noise is caused by interference from other LiDAR systems according to one embodiment. Method 1700 may be performed by LiDAR system 300 illustrated in FIG. 3, LiDAR system 500 illustrated in FIG. 5, LiDAR systems 701 and 702 illustrated in FIG. 7A, and LiDAR systems 821 and 822 illustrated in FIGS. 8A, 8B, 8C, 9A, 9B, 10A and 10B.

Method 1700 includes steps 1710 and 1720. In step 1710, a LiDAR system compares a point cloud of the LiDAR system with data captured from other sensors. In step 1720, the LiDAR system determines that the received noise is caused by interference from the other LiDAR system(s) when noise appears in the point cloud but not in the data captured from the other sensors.

In this embodiment, the LiDAR system may determine if the noise is caused by interference by comparing the point cloud with data captured by Other Vehicle Onboard Sensor(s) 230 in FIG. 2. For example, image and/or video captured by camera 232 may be compared with point cloud data. Since interference among LiDAR systems does not affect cameras, if noise points appear in the point cloud but not in camera data, the LiDAR system may determine that the noise is caused by interference.

FIG. 18 is a flowchart illustrating a method for de-synchronizing two light steering mechanisms of two LiDAR systems according to one embodiment. Method 1800 may be performed by LiDAR system 300 illustrated in FIG. 3, LiDAR system 500 illustrated in FIG. 5, LiDAR systems 701 and 702 illustrated in FIG. 7A, and LiDAR systems 821 and 822 illustrated in FIGS. 8A, 8B, 8C, 9A, 9B, 10A and 10B.

Interference may be reduced or eliminated by de-synchronizing the steering mechanisms of the two LiDAR systems. The steering mechanisms of two LiDAR systems may be synchronized when, after the interference started, the mirrors of the two steering mechanisms move at the same speed. To de-synchronize the two steering mechanisms, the moving speed of mirrors in one steering mechanism may be increased or decreased. However, because the moving speed of mirrors affect the point cloud's resolution, the speed may return to normal after a short period of time. This period should be long enough to adjust the time delay between the two scan patterns of the two LiDAR system, so that interference will not start.

Two or more synchronized LiDAR systems may be de-synchronized by changing the time delay (or position offset) of the synchronized systems. Referring to the interference example depicted in FIGS. 9A and 9B, interference may start when the position offset is 3, but may not start when the position offset is 2. Therefore, adjusting the position offset, or the time delay between the two LiDAR systems may disrupt the initial occurrence of interference. Position offset may be adjusted by changing an operational characteristic, e.g., movement speed, of a mirror in one or both LiDAR systems.

An exemplary method for de-synchronizing two light steering mechanisms by adjusting operational characteristics is illustrated in FIG. 18. Method 1800 includes step 1810, in which a LiDAR system determines, based on a first value of an operational characteristic of the first light steering mechanism, a second value that is different from the first value.

In this embodiment, an operational characteristic is the movement speed of a polygon mirror in the LiDAR system. The amount of speed change, such as, from the first value to the second value, may be calculated using existing parameters. A method to calculate the speed change is illustrated using an example below. The horizontal angular range of frame 902, which is the same as the horizontal FOV range of LiDAR view 802, is 120 degrees. There are 12 points in each scan line, dividing the horizontal FOV into 11 segments. A position offset of 1 point is equivalent to 120°=11=10.9°. Thus, a position offset of 3 points between the two systems can be converted to an azimuthal offset of 10.9°×3=32.7° between the two polygon mirrors. Azimuthal offset is the difference in azimuthal degrees between two same positions of the two polygon mirrors in the two LiDAR systems, at a same point in time. It can be converted to position offset or time delay between the two LiDAR systems. Since the two polygon mirrors rotate at the same speed, at the same point in time, a position on the polygon mirror of system 821 is always 32.7° ahead of the same position of the polygon mirror of system 822. To change the position offset from 3 to 2, the polygon mirror of system 822 would need to speed up to gain an additional azimuthal degree of 10.9°, so that the azimuthal offset between the two mirrors becomes 10.9°×2=21.8°.

To minimize the effect on scan resolution, the speed change of the polygon mirror should be performed relatively quickly, e.g., in 0.1 seconds, 0.5 seconds, or 2 seconds, etc. This period is referred to as the “change period”. In some embodiments, the change period is predetermined. The calculation below uses a change period of 0.5 seconds as an example. If a polygon mirror's current rotation speed is 4,800 rpm (first value), it would rotate 40 times, or 40×360°=14,400°, in every 0.5 seconds. To gain an additional azimuthal degree of 10.9° in 0.5 seconds, the polygon mirror would need to rotate 14,410.9° in 0.5 seconds. This translates to a new rotational speed of 4,803.6 rpm (second value) during the change period.

Method 1800 further includes step 1820, in which the LiDAR system adjusts the operational characteristic of the first light steering mechanism from the first value to the second value. This may be performed, e.g., by control circuitry 350 in FIG. 3 updating the new rotational speed to steering mechanism 340 via communication path 342.

Method 1800 further includes an optional step 1830, in which the LiDAR system adjusts the operational characteristic of the LiDAR system from the second value back to the first value. In some embodiments, after the predetermined change period, e.g., 0.5 seconds, the polygon mirror would return to the normal speed of 4,800 rpm. In this way, by adjusting the rotational speed of the polygon mirror of system 822, the position offset between the two systems is changed from 3 to 2 after the change period.

In method 1800, the position offset is changed from 3 to 2 by accelerating the polygon mirror of system 822. In other embodiments, the same result can also be achieved by decelerating the polygon mirror of system 821. As another example, interference may also be avoided by changing the position offset from 3 to 4, which can be achieved by decelerating the polygon mirror of system 822, or by accelerating the polygon mirror of system 821.

In some embodiments, determining the second value representing the new rotation speed of the polygon mirror includes, determining a time delay between the LiDAR system and the other LiDAR system(s), calculating an angular adjustment value of the polygon mirror based on the time delay, and determining the second value based on the first value and the angular adjustment value.

In some embodiments, determining the time delay between the LiDAR system and the other LiDAR system(s) includes, determining a number of noise counts in a frame based on the detected noise, determining whether the number of noise counts exceeds a threshold noise count, and determining the time delay in accordance with a determination that the number of noise counts exceeds a threshold noise count.

In some embodiments, the number of noise counts decreases as a value of the time delay increases.

In some embodiments, the threshold noise count is determined based on a relation of the number noise counts with respect to a plurality of time delays between at least two LiDAR systems.

In some embodiments, the time delay between the at least two LiDAR systems is zero when the LiDAR systems scan at the same azimuthal angle and the same elevation angle and when the LiDAR systems are scanning the same FOV.

In some embodiments, a plurality of LiDAR systems are in complete synchronization if the time delay between the LiDAR systems is zero.

In some embodiments, a plurality of LiDAR systems may move out of synchronization as the value of the time delay increases.

In some embodiments, adjusting at least one operational characteristic of a first LiDAR system from a second characteristic value back to the first characteristic value includes adjusting the rotation speed of the polygon mirror back to the first rotation speed.

In some embodiments, a method may further comprise redetecting noise caused by interference after de-synchronizing the at least two of the plurality of LiDAR system, and repeating one or more steps in previous embodiments if the redetected noise exceeds a threshold value.

It should be understood that while this disclosure employs examples involving two LiDAR systems to explain the causes of interference and solutions for reducing it, these principles equally apply to scenarios where more than two LiDAR systems are involved.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method for reducing interference in a light ranging and detection (LiDAR) system, the method comprising:
receiving noise by a light detector of the LiDAR system;
determining whether the received noise is caused by interference from at least one other LiDAR system; and
in accordance with a determination that the detected noise is caused by interference from the at least one other LiDAR system, de-synchronizing the LiDAR system with the at least one other LiDAR system.

2. The method of claim 1, wherein receiving noise by the light detector of the LiDAR system further comprises:
detecting scattered light formed based on transmission light from the at least one other LiDAR system.

3. The method of claim 1, wherein a field-of-view of the LiDAR system and a field-of-view of the at least one other LiDAR system at least partially overlap.

4. The method of claim 1, wherein a light steering mechanism of the LiDAR system and a light steering mechanism of the at least one other LiDAR system have at least one operational characteristic that is substantially the same.

5. The method of claim 4, wherein the at least one operational characteristic comprises one or more of a rotational speed, a scanning direction, a scan pattern, a scanning azimuthal angle, a scanning elevation angle, laser light energy, and a pulse repetition rate.

6. The method of claim 1, wherein determining whether the received noise is caused by interference from the at least one other LiDAR system comprises:
comparing a shape of a collective noise points of the received noise in a point cloud of the LiDAR system with a shape of one or more nearby objects in the point cloud; and
determining that the received noise is caused by interference from the at least one other LiDAR system if the shape of the collective noise points resembles the shape of the one or more nearby objects.

7. The method of claim 1, wherein a first outgoing pulse is transmitted by the at least one other LiDAR system, wherein a second outgoing pulse is transmitted by the LiDAR system, and wherein determining whether the received noise is caused by interference from the at least one other LiDAR system comprises:
detecting a first return pulse and a second return pulse after the second outgoing pulse is transmitted, wherein the first return pulse is scattered by an object in an external environment based on the first outgoing pulse, and wherein the second return pulse is scattered by the object in the external environment based on the second outgoing pulse; and
determining, based on the detection of the first return pulse and the second return pulse, whether the received noise is caused by interference from the at least one other LiDAR system.

8. The method of claim 1, wherein determining whether the received noise is caused by interference from the at least one other LiDAR system comprises:
configuring the LiDAR system to operate as a receiver without transmitting light; and
determining that the received noise is caused by interference from the at least one other LiDAR system when the LiDAR system continues to detect return pulses.

9. The method of claim 1, wherein determining whether the received noise is caused by interference from the at least one other LiDAR system comprises:
comparing a point cloud of the LiDAR system with data captured from other sensors; and
determining that the received noise is caused by interference from the at least one other LiDAR system when noise appears in the point cloud but not in the data captured from the other sensors.

10. The method of claim 1, wherein de-synchronizing the LiDAR system with the at least one other LiDAR system comprises at least one of: de-synchronizing a first light source of the LiDAR system and a second light source of the at least one other LiDAR system, and de-synchronizing a first light steering mechanism of the LiDAR system and a second light steering mechanism of the at least one other LiDAR system.

11. The method of claim 10, wherein de-synchronizing the first light source of the LiDAR system and the second light source of the at least one other LiDAR system comprises:
adjusting timings of firing cycles of the LiDAR system such that scattered pulses formed based on transmission light from the at least one other LiDAR system fall outside of detection windows of the LiDAR system.

12. The method of claim 10, wherein de-synchronizing the first light steering mechanism of the LiDAR system and the second light steering mechanism of the at least one other LiDAR system comprises:
determining, based on a first value of an operational characteristic of the first light steering mechanism, a second value that is different from the first value; and
adjusting the operational characteristic of the first light steering mechanism from the first value to the second value.

13. The method of claim 12, further comprises:
adjusting the operational characteristic of the LiDAR system from the second value back to the first value.

14. The method of claim 13, wherein adjusting the operational characteristic of the first light steering mechanism from the first value to the second value is performed within a predetermined time period.

15. The method of claim 13, wherein the operational characteristic comprises at least one of a rotation speed of a polygon mirror and a movement speed of an oscillating mirror.

16. The method of claim 15, wherein determining the second value that is different from the first value comprises:
obtaining the first value representing a current rotation speed of a polygon mirror of the first light steering mechanism;
determining the second value representing a new rotation speed of the polygon mirror; and
adjusting the rotation speed of the polygon mirror to the second value.

17. The method of claim 16, wherein determining the second value representing the new rotation speed of the polygon mirror comprises:
determining a time delay between the LiDAR system and the at least one other LiDAR system;
calculating an angular adjustment value of the polygon mirror based on the time delay; and
determining the second value based on the first value and the angular adjustment value.

18. The method of claim 17, wherein determining the time delay between the LiDAR system and the at least one other LiDAR system comprises:
determining a number of noise counts in a frame based on the detected noise;
determining whether the number of noise counts exceeds a threshold noise count; and
determining the time delay in accordance with a determination that the number of noise counts exceeds a threshold noise count.

19. The method of claim 18, wherein the number of noise counts decreases as a value of the time delay increases.

20. The method of claim 10, wherein de-synchronizing the first light steering mechanism of the LiDAR system and the second light steering mechanism of the at least one other LiDAR system comprises:
adjusting a scan pattern of the LiDAR system to introduce or modify one or more regions of interest (ROIs) in a field-of-view of the LiDAR system.

21. The method of claim 1, wherein de-synchronizing the LiDAR system with the at least one other LiDAR system comprises:
rotating a housing of the LiDAR system to change a field-of-view of the LiDAR system.

22. A LIDAR system for reducing interference in the LiDAR system, comprising:
one or more processors,
a memory device, and
processor-executable instructions stored in the memory device, the processor-executable instructions comprising instructions for:
receiving noise by a light detector of the LiDAR system;
determining whether the received noise is caused by interference from at least one other LiDAR system; and
in accordance with a determination that the detected noise is caused by interference from the at least one other LiDAR system, de-synchronizing the LiDAR system with the at least one other LiDAR system.

23. A vehicle comprising a LiDAR system, the LiDAR system comprising one or more processors and memory, wherein the LiDAR system is configured to perform a method, the method comprising:
receiving noise by a light detector of the LiDAR system;
determining whether the received noise is caused by interference from at least one other LiDAR system; and
in accordance with a determination that the detected noise is caused by interference from the at least one other LiDAR system, de-synchronizing the LiDAR system with the at least one other LiDAR system.

24. A non-transitory computer readable medium storing one or more programs, the one or more programs comprising instructions, which when executed by one or more processors of an electronic device, cause the electronic device to perform a process including:
receiving noise by a light detector of a LiDAR system;
determining whether the received noise is caused by interference from at least one other LiDAR system; and
in accordance with a determination that the detected noise is caused by interference from the at least one other LiDAR system, de-synchronizing the LiDAR system with the at least one other LiDAR system.
